(19) United States
(12) Patent Application Publication
(10) Pub. No.: US 2015/0242391 A1
(43) Pub. Date: Aug. 27, 2015

(54) CONTEXTUALIZATION AND ENHANCEMENT OF TEXTUAL CONTENT

(71) Applicant: Adobe Systems Incorporated, San Jose, CA (US)

(72) Inventors: Naveen Prakash Goel, Noida (IN); Walter W. Chang, San Jose, CA (US); Emre Demiralp, San Francisco, CA (US); Sachin Soni, New Delhi (IN); Rekha Agarwal, Noida (IN)

(21) Appl. No.: 14/189,621

(22) Filed: Feb. 25, 2014

(51) Int. Cl. G06F 17/27

(52) U.S. Cl. CPC G06F 17/2785

(57) ABSTRACT

This document describes techniques for contextualization and enhancement of textual content. In one or more implementations, textual content is analyzed to determine whether the textual content is appropriate for an intended context. The intended context corresponds to an intended mood, emotion, tone, or sentiment of the textual content. If it is determined that the textual content does not conform to the intended context, suggestions are generated to modify the textual content to conform to the intended context.

### BACKGROUND

It is difficult for most people to verbally express emotions, moods, and thoughts in a contextually tailored fashion. One set of phrases or discourse style that is acceptable or appropriate in one domain might be inappropriate in others. For instance, the words and phrases used when communicating with family and friends are expected to be different than those used when communicating with employers, employees or others in a professional or technical context.

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

### SUMMARY

This document describes techniques for contextualization and enhancement of textual content. In one or more implementations, textual content is analyzed to determine whether the textual content is appropriate for an intended context. The intended context corresponds to an intended mood, emotion, tone, or sentiment of the textual content. If it is determined that the textual content does not conform to the intended context, suggestions are generated to modify the textual content to conform to the intended context.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit of a reference number identifies the figure in which the reference number first appears. The use of the same reference numbers in different instances in the description and the figures indicate similar or identical items.

FIG. 1 illustrates an environment in an example implementation that is operable to employ techniques described herein.

FIG. 2 illustrates a system in an example implementation in which a context module is used to generate suggestions to modify textual content to conform to an intended context.

FIG. 3 illustrates an example of a user interface rendered by the context module in accordance with one or more implementations.

FIG. 4 illustrates a procedure in an example implementation in which the context module generates one or more suggestions to modify the textual content to conform to the intended context.

FIG. 5 illustrates an example system including various components of an example device that can be implemented as any type of computing device as described and/or utilized with reference to FIGS. 1-4 to implement embodiments of the techniques described herein.

### DETAILED DESCRIPTION

Overview

Communication is highly contextual. One set of phrases or discourse style that is acceptable or appropriate in one domain might be inappropriate in others. In an increasingly contextualized and digital world where these granular distinctions become all the more important, it is advantageous to fully or partially automate the process of tailoring textual communication.

Some word-processing applications, such as Microsoft® Word, provide spell checkers and suggestions for grammatically incorrect or badly formed sentences. These applications may also make use of a locale-specific thesaurus to suggest synonyms bearing a similar meaning to a selected word. Such applications may even be able to “translate” text from a first language to a second language. None of these existing solutions, however, offer a service to transform text to reflect an intended context, mood, or emotion.

This document describes techniques for contextualization and enhancement of textual content. In one or more implementations, textual content is analyzed to determine whether the textual content is appropriate for an intended context. The intended context corresponds to an intended mood, emotion, tone, or sentiment of the textual content. If it is determined that the textual content does not conform to the intended context, suggestions are generated to modify the textual content to conform to the intended context.

As an example, consider that when a user is writing an email to the user's boss, the user wants the email to be formal. In the past, the user must tailor the content of this email so that it is appropriate for the user's boss by coming up with words or phrase that express a formal or professional tone. Now, the techniques described herein can be utilized to suggest context-appropriate words or phrases to the user that, if accepted by the user, will conform the email to the formal context desired by the user.

As another example, imagine the store Walmart® publicizing a new line of products that are aimed at the group of consumers who are interested in Goth culture. Considering the prevalence of sullen and dark discourse styles in this context, it may be difficult for marketers to come up with the right words to use in a social post to this audience. The techniques described herein can be utilized to automatically replace various words in a social post to a social network, such as Facebook®, to ensure that the post fits the communication style of the particular consumer group of interest.

It is to be appreciated, therefore, that the techniques described herein can be utilized to generate more context-appropriate and professionally written social posts, emails, or documents that convey the appropriate mood and emotions for a given context and intended recipient.

In the following discussion, an example environment is first described that may employ the techniques described herein. Example procedures are then described which may be performed in the example environment as well as other environments. Consequently, performance of the example procedures is not limited to the example environment and the example environment is not limited to performance of the example procedures.

Example Environment

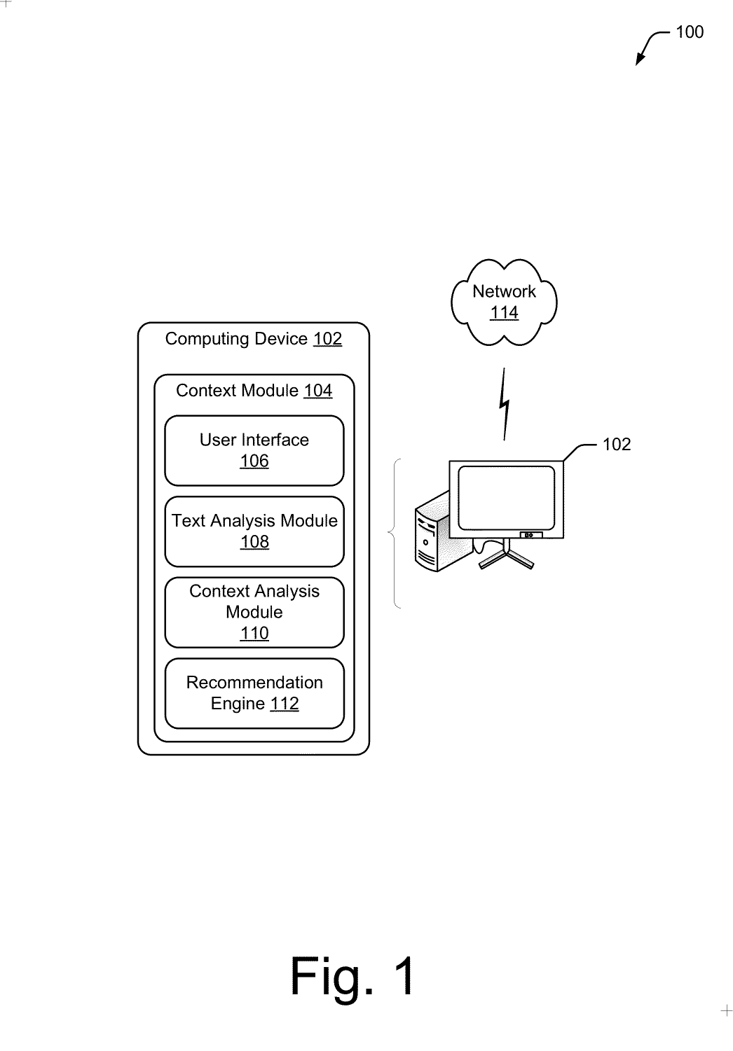

FIG. 1 illustrates an environment 100 in an example implementation that is operable to employ techniques described herein. Environment 100 includes a computing device 102, which may be configured in a variety of different ways.

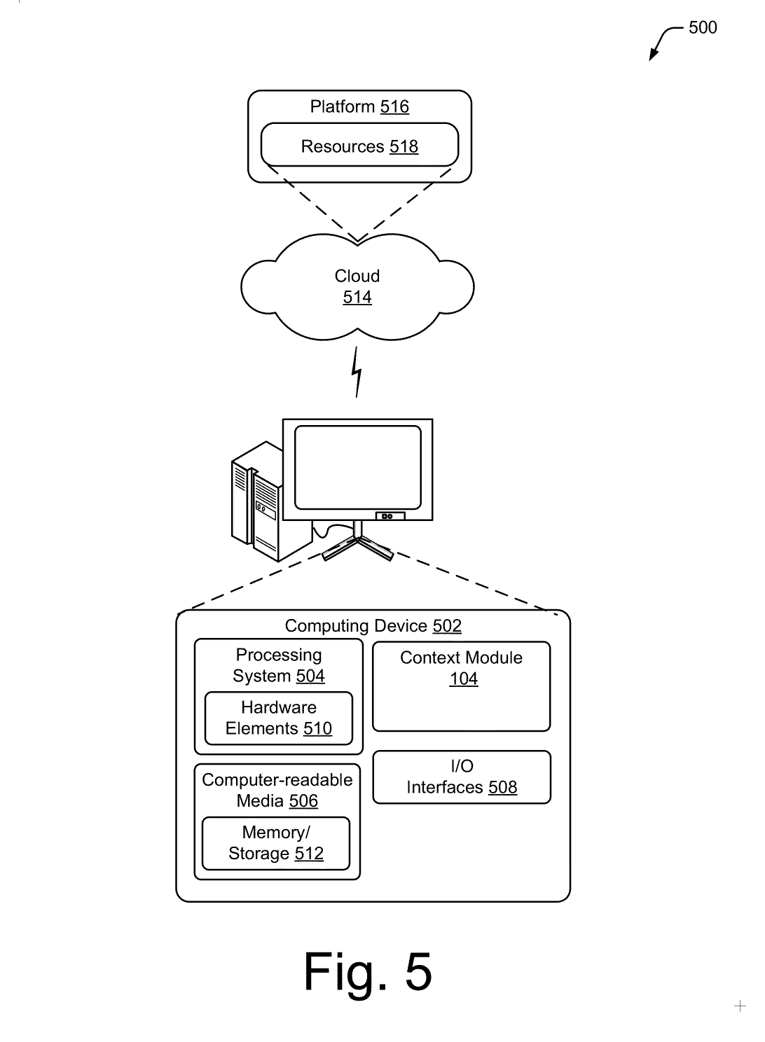

Computing device 102, for instance, may be configured as a desktop computer, a laptop computer, a mobile device (e.g., assuming a handheld configuration such as a tablet or mobile phone), and so forth. Thus, computing device 102 may range from full resource devices with substantial memory and processor resources (e.g., personal computers, game consoles) to a low-resource device with limited memory and/or processing resources (e.g., mobile devices). Additionally, although a single computing device 102 is shown, computing device 102 may be representative of a plurality of different devices, such as multiple servers utilized by a business to perform operations “over the cloud” as further described in relation to FIG. 5.

Computing device 102 is illustrated as including a context module 104, which may also be referred to herein as “module 104”. Module 104 is representative of functionality to perform one or more techniques described herein. Module 104 is configured to determine an intended context of textual content, and to generate suggestions to modify the textual content to conform to the intended context. In one or more implementations, module 104 includes a user interface 106, a text analysis module 108, a context analysis module 110, and a recommendation engine 112.

Module 104 can be implemented, by way of example and not limitation, as a plug-in, a set of templates, a web service, a desktop product, a mobile product, or as any other type of service or application that provides word or phrase level alternate suggestions to enable users to contextualize and enhance textual content. The functionality of module 104 will be discussed in more detail below. Although illustrated as part of computing device 102, functionality of module 104 may also be implemented in a distributed environment, remotely via a network 114 (e.g., “over the cloud”) as further described in relation to FIG. 5, and so on.

Although network 114 is illustrated as the Internet, the network may assume a wide variety of configurations. For example, network 114 may include a wide area network (WAN), a local area network (LAN), a wireless network, a public telephone network, an intranet, and so on. Further, although a single network 114 is shown, network 114 may also be configured to include multiple networks.

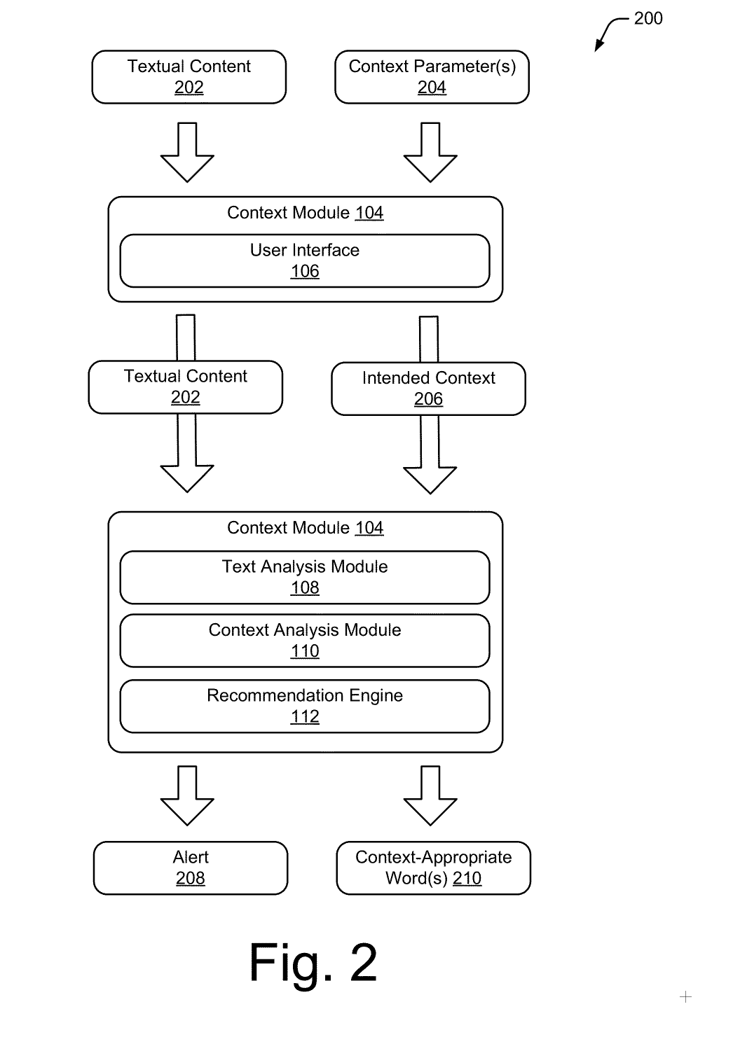

FIG. 2 illustrates a system 200 in an example implementation in which module 104 is used to generate suggestions to modify textual content to conform to an intended context.

In this example, textual content 202 is received from a text-authoring application or any application supporting text by module 104. Module 104 is configured to receive any type of textual content prepared using a text-authoring application. For example, textual content 202 can be a word processing document that is prepared using a word processing application (e.g., Microsoft® Word), an email that is prepared using an email application (e.g., Gmail®), a blog post that is prepared using a blogging application (e.g., Wordpress®), a social post to a social network that is prepared using a social network application (e.g., Adobe® Social or Facebook®), and so on.

In one or more implementations, one or more context parameters 204 are received. Context parameters 204 may be received via user interface 106, which may be implemented within or separate from the text-authoring application. For example, when implemented as a plug-in, module 104 can render a widget or toolbar button which, when selected, presents user interface 106 in the form of a window or dialog box to enable the user to enter context parameters 204. Alternately, when implemented as a set of templates, module 104 may be included within a text-authoring application, and each template can be specific to a particular context. In these implementations, context parameters 204 are received via selection of the particular template.

Context parameters 204 may include any type of parameter that provides information regarding the intended mood, emotion, sentiment, or tone of the textual content and/or the intended recipients or audience of the textual content. In some cases, context parameters 204 include a current mood or emotion of the user. The current mood or emotion of the user may include, by way of example and not limitation, happy, sad, friendly, love, affection, anger, gratitude, or revenge. Context parameters 204 may also correspond to the type of communication or environment of the textual content, such as formal, informal, professional, and so on.

Alternately or additionally, context parameters 204 may include information pertaining to the intended recipient(s) or audience of textual content 202. Such information may include a relationship of the intended recipient to the user, such as friend, parent, sibling, beloved, kid, spouse, relative, boss, or subordinate, to name just a few. Context parameters 204 may also include other information about the intended recipient, such as a location, gender, age group, race, religion, or literacy level of the intended recipient

When textual content 202 corresponds to a social post published on a social network, context parameters 204 may also include an audience on the social network that will view the social post. For example, if the social post is being posted to a brand page on Facebook®, context parameters 204 may include demographic information corresponding to the users that follow or like the brand page, such as an age, gender, location, or interests of users that follow or like the brand page.

In one or more implementations, module 104 renders a predefined list of context parameters 204 in user interface 106 which correspond to the moods or emotions of the user, the type of communication or environment, and/or the intended recipient(s) of textual content 202. This enables the user to quickly and easily select context parameters 204 for textual content 202.

Based on context parameters 204, module 104 determines an intended context 206 of textual content 202. As described herein, the intended context 206 corresponds to the mood, emotion, tone, or sentiment that the user intends to express in textual content 202. For instance, when context parameters 204 correspond to the current mood or emotion of the user, module 104 can determine that the intended context 206 corresponds to a context that expresses the current mood or emotion of the user (e.g., happy, sad, or angry). Similarly, when context parameters 204 correspond to a relationship of the intended recipients of the textual content to a user, module 104 can determine that the intended context corresponds to a context or tone that is appropriate for the intended recipients (e.g., friend, parent, boss). Module 104 may provide a mapping between each category or type of intended recipient and a context that is appropriate for the intended recipient. In one or more implementations, this mapping may be rendered in user interface 106 to enable the user to determine the mapping between each category or type of intended recipient and the context that is appropriate for the intended recipient.

For example, if the intended recipient is the user's boss, module 104 can access this mapping to determine that a context that is appropriate for the user's boss is a formal or professional tone. In contrast, if the intended recipient is a user's friend, module 104 can access the mapping to determine that a context that is appropriate for the user's friend is a casual or informal tone.

Textual content 202 and intended context 206 are then provided to text analysis module 108, which may be implemented local or remote to the computing device that renders user interface 106.

Text analysis module 108 is configured to analyze textual content 202 to identify a sentiment, mood, or emotion of words in textual content 202. As described herein, the term “words” may refer to a single word, or to multiple words such as a phrase. In some cases, text analysis module 108 utilizes a sentence segmentation module, a part-of-speech (POS) tagger, and a sentiment analysis engine to determine a sentiment, mood, or emotion of the words in textual content 202.

For example, module 104 may employ the sentence segmentation module to extract and tokenize words in textual content 202 using natural language processing techniques. The POS tagger can then employ the sentence segmentation module to analyze the extracted words to identify and tag noun phrases, adjectives phrases, and verb phrases, and to create sub-expressions within sentences of textual content 202. Module 104 then employs the sentiment analysis engine to detect the mood, emotion, or sentiment of the extracted words in textual content 202, and of the phrases that are part of the identified noun phrases or adjective phrases. For example, the sentiment analysis engine may score the extracted words or phrases on a scale of positive to negative sentiment, happy to sad emotion, and so on. A more detailed description of an example text analysis module 108 is discussed below in the section entitled “Text Analysis Module”.

Context analysis module 110 is configured determine whether the context of textual content 202 is appropriate for intended context 206. To do so, context analysis module 110 analyzes textual content 202 to identify words, or phrases, that are not appropriate for intended context 206. For example, context analysis module 110 can determine whether words, identified by text analysis module 108, express a mood, emotion, or sentiment that is not appropriate for intended context 206. To determine whether the words express a mood, emotion, or sentiment not appropriate for intended context 206, context analysis module 110 may compare the score of the extracted words or phrases to a threshold. The threshold may be configured by module 104 such that words or phrases with scores that are below the threshold are not appropriate for the intended context. As an example, if intended context 206 corresponds to a positive sentiment, then context analysis module 110 identifies words or phrases with scores that are below a positive sentiment threshold.

In one or more implementations, context analysis module 110 identifies words that are not appropriate for intended context 206 based on a complexity of the words. For example, context analysis module 110 may determine that words in textual content 202 are too large or beyond the educational level of the intended recipients. Similarly, if the intended recipient is very sophisticated, context analysis module 110 may determine that the words in textual content 202 are too simple or basic.

In one or more implementations, context module 104 initiates an alert 208 if one or more words which are not appropriate for the intended context are identified. Context module 104 may initiate rendering of alert 208 in user interface 106 to notify the user that one or more words in textual content 202 are not appropriate for intended context 206. For example, if a user is writing an email to a boss or supervisor, context module 104 may generate an alert if it is determined that the context of the email is casual. As another example, if the user is writing an email that is intended to indicate negative sentiments, recommendation engine 112 may generate an alert if the sentiment of the email is positive.

In one or more implementations, recommendation engine 112 provides a recommendation to the user if one or more words of textual content 202 are not appropriate for the intended context 206. The recommendation may be in the form of one or more suggestions of ways in which textual content 202 can be modified or altered to conform the context of textual content 202 to intended context 206. In some cases, such suggestions may include a suggestion to remove one or more words from textual content 202. For example, if the intended context is positive, recommendation engine 112 may suggest that the user remove certain negative words, such as adjectives that express a negative sentiment or expletives.

Alternately or additionally, such suggestions may include a suggestion to replace one or more words in textual content 202 with one or more context-appropriate words 210. For example, recommendation engine 112 is configured to recommend one or more context-appropriate words 210 to replace the identified words in textual content 202 that are not appropriate for intended context 206. As described herein, context-appropriate words 210 correspond to words, or phrases, of similar meaning to the identified words or phrases that are more appropriate for the intended context 206.

In some cases, module 104 can be implemented to automatically replace the one or more identified words that are not appropriate for the intended context 206, with the one or more context-appropriate words 210 to cause textual content 202 to conform to intended context 206. In other words, context-appropriate words 210 can replace the words not appropriate for the intended context to cause textual content 202 to conform to the mood or emotion appropriate for intended context 206.

In one or more implementations, recommendation engine 112 associates each of the context-appropriate words 210 with one of the identified words or phrases that are not appropriate for intended context 206. Module 104 can then initiate display of textual content 202 in user interface 106, and cause each of the identified words or phrases in textual content 202 to be visually identified in user interface 106. For example, module 104 can visually identify the identified words or phrases by highlighting or underlining the words or phrases in user interface 106.

The visually identified words and phrases are configured to be selected by the user. Responsive to receiving a selection of one of the visually identified words or phrases, module 104 causes one or more corresponding context-appropriate words 210 to be displayed in user interface 106. The user may then accept a context-appropriate word 210 to replace the identified word by selecting the context appropriate word 210 that is displayed in user interface 106. Alternately, the user may reject the context-appropriate word 210 so that textual content 202 remains unchanged.

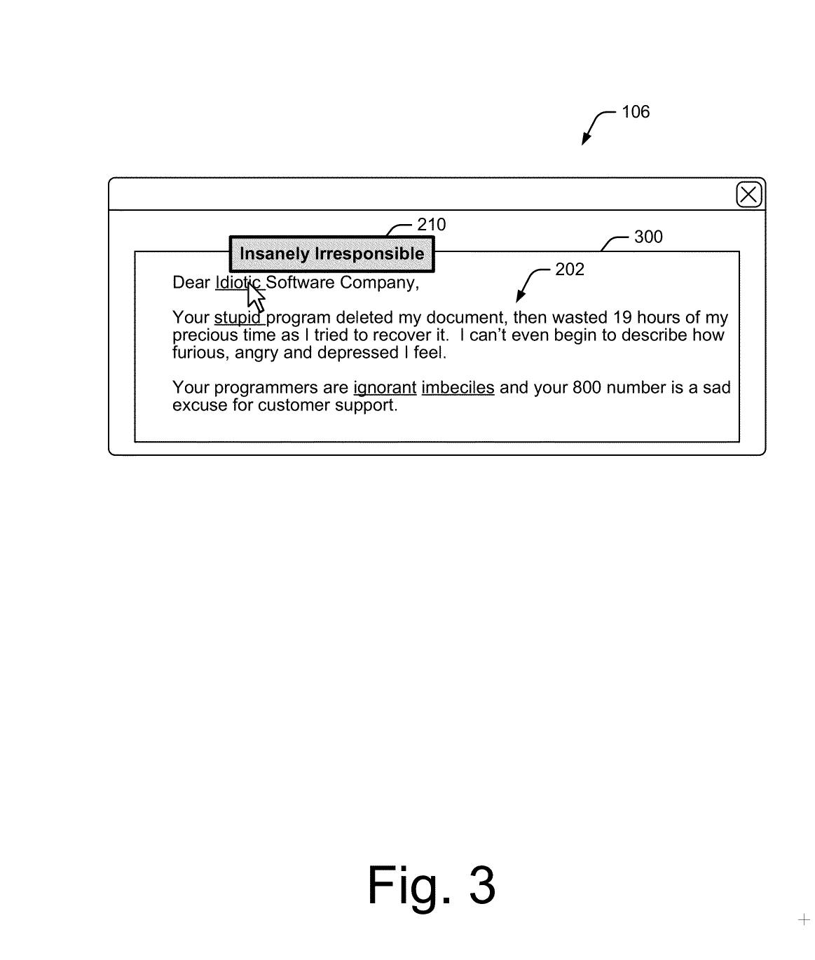

FIG. 3 illustrates an example of user interface 106 rendered by context module 104 in accordance with one or more implementations. In this example, user interface 106 presents a content control 300 which displays textual content 202. As described above, textual content 202 can correspond to any type of textual content. In this example, however, the user has entered textual content in the form of an email, which states:

Dear Idiotic Software Company,

Your stupid program deleted my document, then wasted 19 hours of my precious time as I tried to recover it. I can't even begin to describe how furious, angry and depressed I feel.

Your programmers are ignorant imbeciles and your 800 number is a sad excuse for customer support.

In this example, module 104 is implemented as a set of templates and the user has selected a template that is configured to conform the user's emails to a professional context. Module 104 determines four words within textual content 202 that are not appropriate for the professional context, and visually identifies these four words (“Idiotic”, “stupid”, “ignorant”, and “imbeciles”) in textual content 202 displayed in user interface content control 300. In this example, module 104 visually identifies these words by causing the words to be underlined.

Module 104 may use a variety of different factors to determine the words that are not appropriate for textual content 202. For example, module 104 may determine that the words “insanely irresponsible” are slightly less negative, and more descriptive of the user's feelings towards the software company, than the word “idiotic”. As another example, module 104 may determine that the phrase “insanely irresponsible” is more complex or sophisticated than the word idiotic. Thus, replacing the word “idiotic” with the phrase “insanely irresponsible”, causes the user's email to be more professional because the email is more descriptive of the user's feelings towards the software company and causes the user to appear to possess a greater sophistication.

As described above, when the user selects one of the visually identified words, module 104 causes one or more context-appropriate words 210 to be displayed in user interface 106. In this example, the user has placed a cursor over the visually identified word idiotic. Responsively, module 104 causes context-appropriate words 210, “insanely irresponsible”, to be displayed in user interface 106. Note that the words “insanely irresponsible” has a similar meaning to the word “idiotic”, but the context is more professional.

If the user selects any of the other visually identified words, corresponding context-appropriate words may be displayed to the user. For example, if the user selects the term “stupid”, the context-appropriate words “intelligence lacking” may be displayed to the user; if the user selects the word “ignorant”, the context-appropriate word “nescient” may be displayed to the user; and if the user selects the word “imbeciles”, the context-appropriate word “simpletons” may be displayed to the user. As described above, the user can select any of the context-appropriate words to cause the context-appropriate words to replace the corresponding visually identified word in textual content 202.

While FIG. 3 illustrates an example of user interface 106 which receives textual content in the form of an email, it is to be appreciated that user interface 106 may be utilized to render suggestions for any type of textual content, such as a social post. For example, a company that sells women's running shoes may prepare a social post that says “Hey guys, next week all shoes will be 50% off”. In this example, context module 104 may identify that the word “guys” is not appropriate for the intended audience of the social post, which in this example is predominately females. As such, context module 104 may visually identify the word “guys” in the social post, and render the suggestion “ladies” to replace the word guys. In this example, if the user accepts the suggestions, the social post will be modified to say “Hey Ladies, next week all shoes will be 50% off”. This modified social post is more appropriate for the intended audience of women.

Text Analysis Module

Text analysis module 108 may be implemented in a variety of different ways. One example of text analysis module 108 is described below. Although text analysis module 108 is described as including independent modules, any one or combination of the various modules may be implemented together or independently in the text analysis module in embodiments of contextualization and enhancement of textual content.

In one or more implementations, and as mentioned above, text analysis module 108 may include a POS tagger that is implemented to receive textual content 202 as parts-of-speech information that includes noun expressions, verb expressions, and tagged parts-of-speech of one or more sentences. For example, textual content 202 may include sentences that express positive, neutral, and negative sentiments.

The POS tagger is implemented to identify and tag noun, verb, adjective and adverb sentence fragment expressions, as well as tag and group parts-of-speech of the sentences. The POS tagger may provide a two-level sentence tagging structure for subsequent sentiment annotation. Words within each fragment or phrase are first tagged with their part-of-speech (e.g., as a noun, verb, adjective, adverb, determiner, etc.), and then lexical expression types for each grouping of the words and parts-of-speech tags are assigned. The lexical expression types include noun expressions, verb expressions, and adjective expressions, and the POS tagger generates a two-level sentence expression and parts-of-speech tag structure for each sentence. In one or more implementations, the POS tagger generates an output to a sentiment terms tagging module that may be implemented as part of text analysis module 108. This output may identify the elements of a sentence, such as where the noun expressions are most likely to occur in the sentence, and the adjective expressions that describe the elements in the sentence.

The sentiment terms tagging module is implemented to determine adjective forms of the adjective expressions utilizing a sentiment vocabulary dictionary database to identify meaningful sentence phrases. The text analysis module may receive the parts-of-speech annotated source words and compute the sentiment polarity, intensity, and context for each submitted adjective, adverb, and noun term. The sentiment terms tagging module can utilize the sentiment category vocabulary database, such as a default non-contextualized sentiment vocabulary that is constant across categories, or a domain specific contextualized sentiment vocabulary for selected categories, given one or more category context words. The sentiment terms tagging module can tag and annotate each sentiment word in the two-level tag structure, and generate an annotated data structure.

Text analysis application 108 may also include a sentiment topic model module that receives the annotated data structure and is implemented to identify and extract the key topic noun expressions from each sentence. In implementations, the sentiment topic model module also accepts as input a sentiment neutral topic model, such as from a natural language contextual analysis application, and generates a weighted topic model indicating fine-grain sentiment for specific words and/or lexical terms, such as the noun expressions and adjective expressions. The sentiment topic model module tags the noun terms of a sentence that is processed as the textual content 202 as topics of the sentence based on the noun expressions, and associates each of the topics with the sentiment about the subject of the sentence.

As described above, text analysis module 108 may also include a sentiment analysis engine that is implemented to aggregate the sentiment about the subject for each of the one or more topics of the sentence to score each of the noun expressions as represented by one of the topics of the sentence. The sentence phrase sentiment scoring module computes the overall emotion, mood, tone, or sentiment polarity and score for each topic model noun expression and sentence based on the earlier sentiment annotations and scores for each expression (or fragment) using individual word sentiment term scores and counts. The sentence and phrase-level sentiment scoring is performed to assign a positive or negative value score to each specific phrase within a sentence based on the presence of affect and sentiment keywords in that phrase. Phrase-level sentiment and affect scores are then summed to yield a sentence level score normalized by the total number of adjectives, adverbs, and nouns in the sentence. Sentences may have a zero score in the event no sentiment or affect keywords are detected.

As described above, context analysis module 110 may then determine whether words and phrases, identified by text analysis module 108, express a mood, emotion, or sentiment that is not appropriate for intended context 206. To determine whether the words express a mood, emotion, or sentiment not appropriate for intended context 206, context analysis module 110 may compare the normalized sentence level scores of the extracted words or phrases to a threshold.

Example Procedure

The following discussion describes techniques that may be implemented utilizing the systems and devices described herein. Aspects of the procedure may be implemented in hardware, firmware, or software, or a combination thereof. The procedure is shown as a set of blocks that specify operations performed by one or more devices and are not necessarily limited to the orders shown for performing the operations by the respective blocks. In portions of the following discussion, reference will be made to FIGS. 1 and 2.

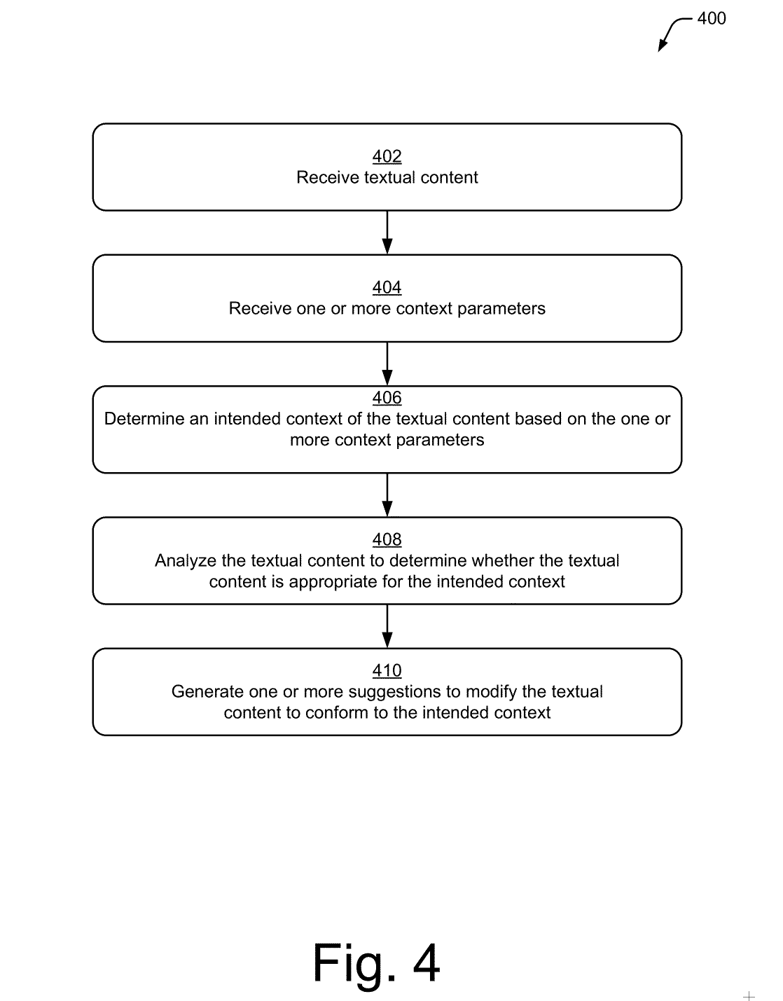

FIG. 4 illustrates a procedure 400 in an example implementation in which context module 104 generates one or more suggestions to modify the textual content to conform to the intended context.

At 402, textual content is received. For example, module 104 receives textual content 202 from a text authoring application or any application supporting text.

At 404, one or more context parameters are received. For example, module 104 receives content parameters 204 via user interface 106. Context parameters 204 may include any type of parameter that provides information regarding the intended mood, emotion, sentiment, or tone of the textual content and/or the intended recipients or audience of the textual content.

At 406, an intended context of the textual content is determined based on the one or more context parameters. For example, module 104 can determine an intended context 206 of textual content 202 based on one or more context parameters 204. The intended context 206 corresponds to the mood, emotion, tone, or sentiment that the user intends to express in textual content 202. For instance, when context parameters 204 correspond to the current mood or emotion of the user, module 104 can determine that the intended context 206 corresponds to a context that expresses the current mood or emotion of the user (e.g., happy, sad, or angry). Similarly, when context parameters 204 correspond to a relationship of the intended recipients of the textual content to a user, module 104 can determine that the intended context corresponds to a context or tone that is appropriate for the intended recipients (e.g., friend, parent, or boss).

At 408, the textual content is analyzed to determine whether the textual content is appropriate for the intended context. For example, context module 104 can analyze textual content 202. If context module 104 identifies one or more words that are not appropriate for intended context 206, module 104 can determine that the textual content is not appropriate, or not suitable, for the intended context.

At 410, one or more suggestions are generated to modify the textual content to conform to the intended context. For example, responsive to determining that the textual content is not appropriate for the intended context, module 104 can recommend one or more context-appropriate words 210 to replace the one or more identified words in textual content 202 that are not appropriate for intended context 206. Alternately or additionally, responsive to determining that the textual content is not appropriate for the intended context, context module 104 can initiate display of an alert 208 in user interface 106 that indicates the textual content is not appropriate for intended context 206.

In one embodiment, procedure 400 does not include receiving a positive context or positive sentiment as a default value for the intended context 206 of the textual content 202. Instead, procedure 400 includes an explicit step 406 for determining the intended context 206.

In another embodiment, procedure 400 does not include receiving a positive context or positive sentiment as a default value for the intended context 206 of the textual content 202 but instead includes step 406. In this embodiment, step 406 includes necessarily determining a negative sentiment or negative context as the intended context 206 of the textual content, and analyzing the textual content 202 (step 408) to determine that certain words indicating positive sentiments or positive context are present in the textual content 202. One or more suggestions of negative words or negative context are then provided as alternative or replacement for determined words indicating positive sentiments or positive context.

Having described an example procedure in accordance with one or more implementations, consider now an example system and device that can be utilized to implement the various techniques described herein.

Example System and Device

FIG. 5 illustrates an example system generally at 500 that includes an example computing device 502 that is representative of one or more computing systems and/or devices that may implement the various techniques described herein. This is illustrated through inclusion of context module 104, which operates as described above. The computing device 502 may be, for example, a server of a service provider, a device associated with a client (e.g., a client device), an on-chip system, and/or any other suitable computing device or computing system.

The example computing device 502 is illustrated includes a processing system 504, one or more computer-readable media 506, and one or more I/O interface 508 that are communicatively coupled, one to another. Although not shown, the computing device 502 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 504 is representative of functionality to perform one or more operations using hardware. Accordingly, the processing system 504 is illustrated as including hardware elements 510 that may be configured as processors, functional blocks, and so forth. This may include implementation in hardware as an application specific integrated circuit or other logic device formed using one or more semiconductors. The hardware elements 510 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable storage media 506 is illustrated as including memory/storage 512. The memory/storage 512 represents memory/storage capacity associated with one or more computer-readable media. The memory/storage component 512 may include volatile media (such as random access memory (RAM)) and/or nonvolatile media (such as read only memory (ROM), Flash memory, optical disks, magnetic disks, and so forth). The memory/storage component 512 may include fixed media (e.g., RAM, ROM, a fixed hard drive, and so on) as well as removable media (e.g., Flash memory, a removable hard drive, an optical disc, and so forth). The computer-readable media 506 may be configured in a variety of other ways as further described below.

Input/output interface(s) 508 are representative of functionality to allow a user to enter commands and information to computing device 502, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 502 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 502. By way of example, and not limitation, computer-readable media may include “computer-readable storage media” and “computer-readable signal media.”

“Computer-readable storage media” refers to media and/or devices that enable persistent and/or non-transitory storage of information in contrast to mere signal transmission, carrier waves, or signals per se. Thus, computer-readable storage media does not include signals per se or signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” refers to a signal-bearing medium that is configured to transmit instructions to the hardware of the computing device 502, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 510 and computer-readable media 506 are representative of modules, programmable device logic and/or fixed device logic implemented in a hardware form that may be employed in some implementations to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 510. The computing device 502 may be configured to implement particular instructions and/or functions corresponding to the software and/or hardware modules. Accordingly, implementation of a module that is executable by the computing device 502 as software may be achieved at least partially in hardware, e.g., through use of computer-readable storage media and/or hardware elements 510 of the processing system 504. The instructions and/or functions may be executable/operable by one or more articles of manufacture (for example, one or more computing devices 502 and/or processing systems 504) to implement techniques, modules, and examples described herein.

The techniques described herein may be supported by various configurations of the computing device 502 and are not limited to the specific examples of the techniques described herein. This functionality may also be implemented all or in part through use of a distributed system, such as over a “cloud” 514 via a platform 516 as described below.

The cloud 514 includes and/or is representative of a platform 516 for resources 518. The platform 516 abstracts underlying functionality of hardware (e.g., servers) and software resources of the cloud 514. The resources 518 may include applications and/or data that can be utilized while computer processing is executed on servers that are remote from the computing device 502. Resources 518 can also include services provided over the Internet and/or through a subscriber network, such as a cellular or Wi-Fi network.

The platform 516 may abstract resources and functions to connect the computing device 502 with other computing devices. The platform 516 may also serve to abstract scaling of resources to provide a corresponding level of scale to encountered demand for the resources 518 that are implemented via the platform 516. Accordingly, in an interconnected device implementation, implementation of functionality described herein may be distributed throughout the system 500. For example, the functionality may be implemented in part on the computing device 502 as well as via the platform 516 that abstracts the functionality of the cloud 514.

### CONCLUSION

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A computer-implemented method comprising:
determining an intended context of textual content based on one or more context parameters;
analyzing the textual content to determine whether the textual content is appropriate for the intended context; and
responsive to determining that the textual content is not appropriate for the intended context, generating one or more suggestions to modify the textual content to conform to the intended context.

2. The computer-implemented method of claim 1, wherein the analyzing further comprises analyzing the textual content to identify one or more words that are not appropriate for the intended context.

3. The computer-implemented method of claim 2, wherein the generating further comprises suggesting removal of one or more of the identified words from the textual content.

4. The computer-implemented method of claim 2, wherein the generating further comprises determining one or more context-appropriate words to replace the one or more identified words in the textual content.

5. The computer-implemented method of claim 4, wherein the one or more context-appropriate words comprise words or phrases of similar meaning to the identified words in the textual content that are more appropriate for the intended context.

6. The computer-implemented method of claim 4, further comprising replacing the one or more identified words in the textual content with respective ones of the context-appropriate words to cause the textual content to conform to the intended context.

7. The computer-implemented method of claim 4, further comprising:
associating each of the one or more context-appropriate words with a respective identified word in the textual content;
initiating display of the textual content in a user interface; and
causing each of the identified words to be visually identified in the user interface.

8. The computer-implemented method of claim 7, further comprising:
responsive to receiving a selection of one of the visually identified words via the user interface, causing display of one or more context-appropriate words associated with the selected word; and
responsive to receiving a selection of one of the context-appropriate words via the user interface, modifying the textual content by replacing the selected word with the selected context-appropriate word.

9. The computer-implemented method of claim 1, further comprising responsive to determining that the textual content is not appropriate for the intended context, initiating display of an alert in a user interface, the alert indicating that the textual content is not appropriate for the intended context.

10. The computer-implemented method of claim 1, wherein the one or more context parameters include a current mood or emotion of a user that writes the textual content, and wherein the determining further comprises determining that the intended context corresponds to a context that expresses the current mood or emotion of the user.

11. The computer-implemented method of claim 1, wherein the one or more context parameters include information pertaining to one or more intended recipients of the textual content, and wherein the determining further comprises determining that the intended context corresponds to a context that is appropriate for the one or more intended recipients.

12. The computer-implemented method of claim 1, further comprising receiving the textual content via a text-authoring application, the text-authoring application comprising one of an email application, a word processing application, or a social network application.

13. One or more computer-readable storage media comprising instructions stored thereon that, responsive to execution by a computing device, cause the computing device to implement a context module, the context module configured to perform operations comprising:
receiving textual content;
receiving one or more context parameters;
determining an intended context of the textual content based on the one or more context parameters;
analyzing the textual content to identify one or more words that are not appropriate for the intended context; and
responsive to identifying one or more words that are not appropriate for the intended context, initiating an alert indicating that one or more words in the textual content are not appropriate for the intended context.

14. The or more computer-readable storage media of claim 13, wherein the context module is further configured to recommend one or more context-appropriate words to replace the one or more identified words in the textual content.

15. The or more computer-readable storage media of claim 13, wherein the instructions, responsive to execution by the processor, are configured to perform operations further comprising:
associating each of the one or more context-appropriate words with a respective identified word in the textual content;
initiating display of the textual content in a user interface;
causing each of the identified words to be visually identified in the user interface;
responsive to receiving a selection of one of the visually identified words via the user interface, initiating display of one or more context-appropriate words associated with the selected word; and
responsive to receiving a selection of one of the context-appropriate words via the user interface, modifying the textual content by replacing the selected word with the selected context-appropriate word.

16. The one or more computer-readable storage media of claim 13, wherein the context parameters correspond to a current mood or emotion of a user that writes the textual content, or one or more intended recipients of the textual content.

17. The one or more computer-readable storage media of claim 13, wherein the context module is implemented as a plug-in to the text-authoring application.

18. The one or more computer-readable storage media of claim 13, wherein the context module is implemented as a set of templates for the text-authoring application.

19. A computing device comprising:
at least a memory and a processor to implement a context module, the context module configured to:
determine an intended mood of textual content based at least in part on a current mood of a user that writes the textual content;
analyze the textual content to identify one or more words that are not appropriate for the intended mood; and
responsive to identifying one or more words that are not appropriate for the intended mood, determining one or more context-appropriate words to replace the one or more identified words in the textual content.

20. The computing device of claim 19, wherein the context module is further configured to initiate an alert indicating that one or more words in the textual content are not appropriate for the intended mood.
